(19) United States
(12) Patent Application Publication
(10) Pub. No.: US 2013/0067909 A1
(43) Pub. Date: Mar. 21, 2013

(54) CURVED MULTIMORPH MICROACTUATORS THAT BEND AND/OR TWIST

(71) Applicants: Sagnik Pal, Kolkata (IN); Huikai Xie, Gainesville, FL (US); Karl R. Zawoy, High Springs, FL (US)

(72) Inventors: Sagnik Pal, Kolkata (IN); Huikai Xie, Gainesville, FL (US); Karl R. Zawoy, High Springs, FL (US)

(73) Assignee: UNIVERSITY OF FLORIDA RESEARCH FOUNDATION, INC., GAINESVILLE, FL (US)

(21) Appl. No.: 13/701,793

(22) PCT Filed: Jun. 1, 2011
(86) PCT No.: PCT/US11/38786

§ 371 Date: Dec. 3, 2012

Related U.S. Application Data
(60) Provisional application No. 61/350,137, filed on Jun. 1, 2010.

(51) Int. Cl. F03G 7/06

(52) U.S. Cl. CPC F03G 7/065
USPC 60/529

(57) ABSTRACT

A curved multimorph actuator is provided composed of a plurality of materials, each material exhibiting different deformations in response to a stimulus, such as heat. Application of different stimuli causes the actuator to bend and/or twist. In an embodiment, the actuator is capable of rotating an object about its center without significantly shifting the center in one or more dimensions. In a further embodiment, the actuator can be used to rotate an object about a first axis and a second axis, wherein the first axis and the second axis are mutually perpendicular. In an embodiment, rotation about the first axis and the second axis are achieved in combination. In another embodiment, rotation about the first axis is produced in response to a first stimulus and rotation about the second axis is produced in response to a second stimulus.

### CROSS-REFERENCE TO RELATED APPLICATION(S)

The present application claims the benefit of U.S. Provisional patent application No. 61/350,137, filed Jun. 1, 2010, which is hereby incorporated by reference herein in its entirety, including any figures, tables, or drawings.

The subject invention was made with government support under National Science Foundation, Contract No. 0725598. The government has certain rights to this invention.

### BACKGROUND OF INVENTION

A variety of mechanisms that can be used for actuation in Micro-Electro-Mechanical System (MEMS) design include thermal, electrothermal, magnetic, electromagnetic, piezoelectric, magnetostrictive, electrostatic, and shape-memory alloy (SMA), actuation. A multimorph actuator or sensor incorporates two or more materials, wherein each material deforms differently upon application of a stimulus, such as heat, a magnetic field, a voltage potential, among other possible stimuli. A two material multimorph is typically referred to as a bimorph. The materials are typically formed in layers and stacked as shown in FIG. 6. Difference in strains produced in the layers of a multimorph generally produces bending, thereby leading to actuation.

Multimorph actuators are typically composed of topologically straight beams. The theory of straight multimorphs is well developed [S. Timoshenko, Journal of Optical Society of America, vol. 11, pp. 233-256, 1925]. But little attention has been paid to topologically curved multimorphs. Xu et al. reported the fabrication of a 2D electrothermal micromirror actuated by curved bimorphs [Y. Xu, J. Singh, C. S. Premachandran, A. Khairyanto, K. W. S. Chen, N. Chen, C. J. R. Sheppard, and M. Olivo, J. Micromech. Microeng., 18, 125005, 2008]. Shi et al. reported the analysis of curved bimorphs whose constituent layers lie in the same plane [Z. Shi, Smart Mater. and Struct., 14, 835, 2005]. Such structures undergo in-plane bending but do not twist upon actuation. The analysis of curved bimorphs that undergo out-of-plane bending and twisting has not been reported before.

Microactuators can be used in various applications, such as biomedical imaging, optical displays, laser beam steering, communications, space exploration, and surveillance, among other applications. In particular, micoractuators can be used to produce a scanning motion with an object, such as an antenna, radiation beam, laser beam, mirror, among other objects. A micromirror is an optical semiconductor device that has mirror plate moved by one or more microactuators. 2D micromirrors typically utilize two or more actuators for achieving 2D scan and therefore require more than one signal line [A. Jain, PhD Thesis Dissertation, University of Florida, 2006; L. Wu and H. Xie, IEEE Transducers 2007]. Currently, state-of-the-art 2D scanning mirrors employ as many as 4 signal lines [K. Jia, S. Pal, and H. Xie, J. MEMS, 18, 1004-1015, 2009]. This makes system miniaturization difficult. Lammel et al. reported L-shaped actuators that can realize 2D scan using a single actuator [G. Lammel, S. Schweizer, and P. Renaud, Optical Microscanners and Microspectrometers Using Thermal Bimorph Actuators: Kluwer Academic Publishers, 2002]. But such L-shaped actuators produce significant mirror-plate center shift during actuation which makes optical alignment difficult.

### BRIEF SUMMARY

Embodiments of the subject invention relate to a method and apparatus for providing a curved multimorph actuator capable of both bending and twisting deformations. Such actuators can be used for various applications, such as, but not limited to biomedical imaging, optical displays, laser beam steering, communications, space exploration, and surveillance, among other applications. In a specific embodiment, such an actuator can be used to produce a scanning motion with an object, such as an antenna, radiation beam, laser beam, mirror, among other objects. In an embodiment, an actuator is used to move an object, such a mirror plate. In a further embodiment, a plurality of actuators is used to move the object. One or more actuators can generate tip/tilt and piston (TTP) motions of the object. In an embodiment, such actuators are capable of rotating the object about an axis. In a particular embodiment, a single actuator is capable of rotating the object about its center without significantly shifting the center of the object in one or more dimensions. In a further embodiment, a single actuator can be used to rotate an object about a first axis and to rotate the same object about a second axis, wherein the first axis and the second axis are mutually perpendicular. In an embodiment, rotation about the first axis and the second axis are achieved sequentially by providing a first stimulus to the actuator to achieve rotation about the first axis and providing a second stimulus to the actuator to achieve rotation about the second axis. In a specific embodiment, rotation about the first axis is produced in response to a first electrical current pattern that heats the actuator in a first pattern and rotation about the second axis is produced in response to a second electrical current pattern that heats the actuator in a second pattern. The first and second current pattern can drive electrical currents to different portions of the actuator, can drive different magnitude electrical currents to all or portions of the actuator, or a combination thereof.

A multimorph actuator can be provided that incorporates a plurality of materials. Each material can exhibit different deformations in response to a stimulus, such as heat. In an embodiment, three or more different materials are used. In another embodiment, a bimorph actuator is incorporating two different materials. The materials of the multimorph can be formed in layers, such as thin-film layers, and stacked. In an embodiment, the layers have uniform thicknesses, widths, and cross-sections. In another embodiment, the thickness of the different layers can vary. In yet another embodiment, the materials can have different widths or cross-sections.

### BRIEF DESCRIPTION OF DRAWINGS

FIGS. 1A-1B show schematics of a curved bimorph in accordance with an embodiment of the subject invention, wherein FIG. 1A shows the curved bimorph in an undeformed condition and FIG. 1B shows the curved bimorph on actuation.

FIGS. 2A-2B show the geometry of a section of a curved beam, wherein FIG. 2A shows a portion of the curved beam and FIG. 2B shows a cross-section of the curved beam.

FIG. 3 shows a section of a curved bimorph in accordance with an embodiment of the subject invention.

FIGS. 4A-4B show analytical and finite element (FE) simulated tip-deflections (FIG. 4A) and beam twists (FIG. 4B) produced by embodiments of the subject invention.

FIG. 5 shows analytical and finite element (FE) simulated vertical deflections produced by an embodiment of the subject invention.

FIG. 6 shows a schematic of a 1D electrothermal micromirror actuated by a straight bimorph.

FIGS. 7A-7B show schematics of a semicircular multimorph actuator in accordance with an embodiment of the subject invention, wherein FIG. 7A shows the actuator in an undeformed condition and FIG. 7B shows an FE simulation of the actuator after application of a stimulus.

FIGS. 8A-8B show schematics of a circular multimorph actuator attached to a mirror plate in accordance with an embodiment of the subject invention, wherein FIG. 8A shows an FE simulation of the actuator tilting the mirror plate in a first dimension in response to a first stimulus and FIG. 8B shows an FE simulation of the actuator tilting the mirror plate in a second dimension in response to a second stimulus.

FIGS. 9A-9B show schematics of an elliptical multimorph actuator attached to a mirror plate in accordance with an embodiment of the subject invention, wherein FIG. 9A shows an FE simulation of the actuator scanning about x-axis and FIG. 9B shows an FE simulation of the actuator scanning about a y-axis.

FIGS. 10A-10D show schematics of an semicircular multimorph actuator attached to a mirror plate in accordance with an embodiment of the subject invention, wherein FIG. 10A shows a top view of the actuator, FIG. 10B shows an FE simulation of the actuator tilting the mirror plate in response to a stimulus, FIG. 10C shows an FE simulation of the actuator scanning substantially about y-axis of the mirror plate, and FIG. 10D shows an FE simulation of the actuator scanning substantially about x-axis of the mirror plate.

FIGS. 11A-11B show schematics of a curved lateral-shift-free (LSF) actuator in accordance with an embodiment of the subject invention, wherein FIG. 11A shows the actuator in an undeformed condition and FIG. 11B shows an FE simulation of the actuator after application of a stimulus.

FIGS. 12A-12B show schematics of a curved inverted-series connected (ISC) actuator in accordance with an embodiment of the subject invention, wherein FIG. 12A shows the actuator in an undeformed condition and FIG. 12B shows an FE simulation of the actuator after application of a stimulus.

FIG. 13 shows a top view of a curved ISC actuator having constituent bimorphs with different widths in accordance with an embodiment of the subject invention.

FIGS. 14A-14B show cross-sectional areas of bimorphs in accordance with embodiments of the subject invention, wherein FIG. 14A shows a cross-section of a bimorph having horizontal symmetry and FIG. 14B shows a cross-section of a bimorph lacking horizontal symmetry.

FIG. 15 shows a SEM of a curved multimorph test structure in accordance with an embodiment of the invention.

FIG. 16 shows results for the structure shown in FIG. 15.

FIG. 17A shows a SEM of a circular micromirror actuated by a semicircular electrothermal multimorph in accordance with an embodiment of the invention.

FIG. 17B shows a simulated initial tilt of micromirror upon release of the micromirror of FIG. 17A, where the color bar shows the total displacement from the unreleased, i.e., flat position.

FIG. 17C shows a cross-section of multimorph actuator shown in FIG. 17A (not to scale).

FIGS. 18A-18B show experimentally obtained static characteristic of the micromirror shown in FIG. 17A along with Finite Element (FE) simulation data, where FIG. 18A shows optical scan angle vs. applied voltage and FIG. 18B optical scan angle vs. input power.

FIG. 19 shows the frequency response of the micromirror shown in FIG. 17A, where the actuation voltage is a sinusoid of amplitude 17.5 mV at a dc bias of 608.5 mV.

FIGS. 20A-20C show resonant modes of the micromirror shown in FIG. 17A, where FIG. 20A shows the resonant mode at 104 Hz, FIG. 20B shows the resonant mode at 400 Hz, and FIG. 20C shows the resonant mode at 416 Hz.

FIGS. 21A-21C show two-dimensional scanning using the mirror shown in FIG. 17A, where FIG. 21A shows a scan pattern generated by a 400 Hz, 0-500 mV sinusoidal actuation voltage, FIG. 21B shows a scan pattern generated by a 400 Hz, 0-500 mV sine wave amplitude modulated at 10 Hz and a depth of modulation of 100%, and FIG. 21C shows a smiley face pattern generated by driving the laser diode with a signal synchronized with the mirror actuation waveform.

FIG. 22A shows an SEM of an electrothermal micromirror actuated by elliptical multimorph in accordance with an embodiment of the invention, where the elliptical mirror-plate has 140 μm major axis and 90 μm minor axis.

FIG. 22B shows a cross-section of the curved multimorph of FIG. 22A (not to scale).

FIGS. 23A-23B show experimentally obtained static characteristic of the micromirror shown in FIG. 22A, where FIG. 23A shows optical angle vs. dc voltage and FIG. 23B shows optical angle vs. dc power input for device.

FIG. 24 shows the frequency response obtained for the mirror shown in FIG. 22A, where the actuation signal is a sine wave of 16 mV amplitude at 334 mV offset

FIG. 25 shows a center-shift for the mirror shown in FIG. 22A, where the center-shifts produced by bending and twisting of the curved multimorph are in opposite directions and this results in an overall low center-shift.

FIGS. 26A-26C show mutually perpendicular scan modes of the mirror shown in FIG. 22A, where FIG. 26A is at 8.6 kHz and FIG. 26B is at 17 kHz, and FIG. 26C shows a two-dimensional scan pattern generated by the mirror shown in FIG. 22A, where the mirror is actuated by a 0-312 mV, 17 kHz sinusoidal waveform amplitude modulated at 8.04 kHz.

### DETAILED DISCLOSURE

Embodiments of the subject invention relate to a method and apparatus for providing a curved multimorph actuator capable of both bending and twisting deformations. In a specific embodiment, the bimorph can lie in a plane and have a curve in the plane, where the layers of materials are parallel to the plane, and where heat is applied by driving electric current along the length of at least portions of the actuator. The actuator bends out of the plane and twists over at least segments of the length of the actuator. Such actuators can be used for various applications, such as, but not limited to, biomedical imaging, optical displays, laser beam steering, communications, space exploration, and surveillance, among other applications. In a specific embodiment, such an actuator can be used produce a scanning motion with an object, such as an antenna, radiation beam, laser beam, minor, among other objects. In an embodiment, an actuator is used to move an object, such a mirror plate. In a further embodiment, a plurality of actuators is used to move the object. One or more actuators can generate tip/tilt and piston (TTP) motions of the object. In an embodiment, such actuators are capable of rotating the object about an axis. In a particular embodiment, a single actuator is capable of rotating the object about its center without significantly shifting the center of the object in one or more dimensions. In a further embodiment, a single actuator can be used to rotate an object about a first axis and to rotate the same object about a second axis, wherein the first axis and the second axis are mutually perpendicular. In an embodiment, rotation about the first axis and the second axis are achieved sequentially by providing a first stimulus to the actuator to achieve rotation about the first axis and providing a second stimulus to the actuator to achieve rotation about the second axis. In a specific embodiment, rotation about the first axis is produced in response to a first electrical current pattern that heats the actuator in a first pattern and rotation about the second axis is produced in response to a second electrical current pattern that heats the actuator in a second pattern. The first and second current pattern can drive electrical currents to different portions of the actuator, can drive different magnitude electrical currents to all or portions of the actuator, or a combination thereof.

In an embodiment, a multimorph actuator is provided that incorporates a plurality of materials. Each material can exhibit different deformations in response to a stimulus, such as heat. In an embodiment, three or more different materials are used. In another embodiment, a bimorph actuator is provided incorporating two different materials. The materials of the multimorph are formed in layers, such as thin-film layers, and stacked. In an embodiment, the layers have uniform thicknesses, widths, and cross-sections. In another embodiment, the thickness of the different layers can vary. In yet another embodiment, the materials can have different widths or cross-sections.

As further discussed below, embodiments of the subject invention have been validated via analysis and finite element (FE) simulations results. The analysis is applicable to multimorphs of arbitrary shape. The analysis draws upon the theory of multimorphs, S. Timoshenko, Journal of Optical Society of America, vol. 11, pp. 233-256, 1925, and the theory of curved beams, A. E. Armenàkas, Advanced Mechanics of Materials and Applied Elasticity. Boca Raton: CRC Taylor & Francis, 2005.; A. Blake, Handbook of Mechanics, Materials, and Structures. New York: Wiley, 1985.

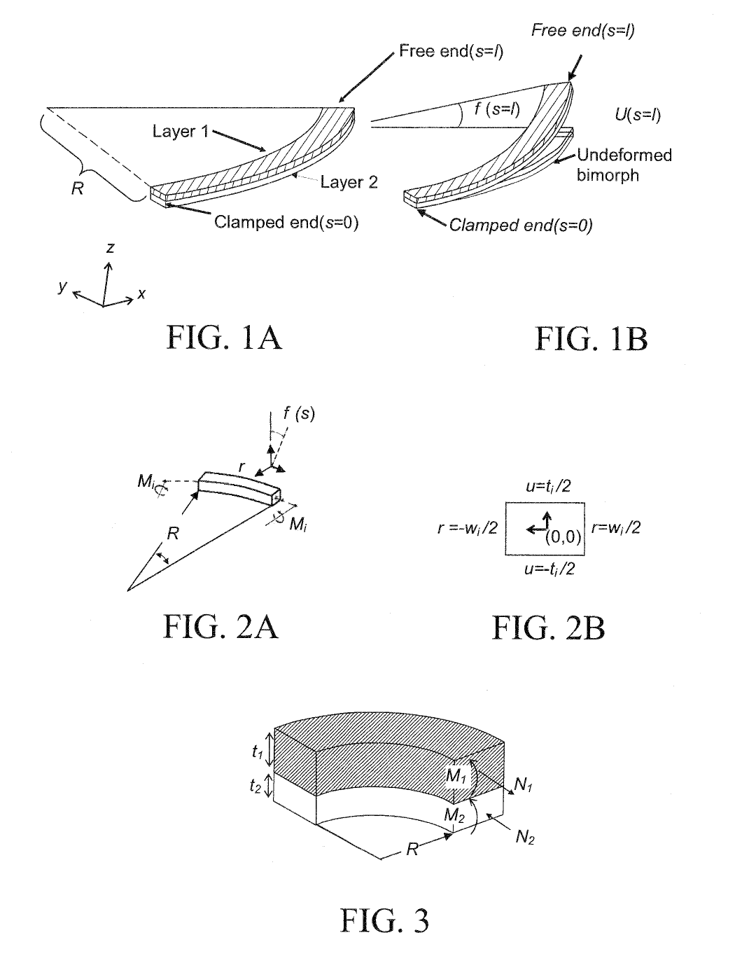

FIGS. 1A-1B show schematics of a curved bimorph in accordance with an embodiment of the subject invention. FIG. 1A shows the schematic of a curved bimorph of length l and width w. The distance along the bimorph is s. In the embodiment shown, the bimorph is clamped at s=0. In another embodiment, a portion of the bimorph is fixed in another manner. FIG. 1B shows deformation of the curved bimorph on actuation. In the embodiment shown, the curved bimorph exhibits both out-of-plane bending and twisting on actuation. The beam twist angle φ(s) and vertical displacement U(s) are indicated.

As in the case of straight bimorphs [S. Pal and H. Xie, J. Micromech. Microeng., 20, 045020, 2010.], key equations in curved bimorph analysis are the beam deformation equations, the force and moment balance equations, and strain continuity at the interface between the two layers. The bending and twisting of curved actuators can be determined based on these equations, allowing the design of curved actuators in accordance with embodiments of the invention.

FIG. 2A shows a section of a curved beam of in-plane radius of curvature R subjected to a bending moment Mᵢ. The thickness, width, Young's modulus, and cross-sectional moment of inertia are tᵢ, wᵢ, Eᵢ, and Iᵢ respectively. The subscript i will later he used to denote the ith layer of a curved bimorph, i=1, 2, or multimorph, i=1 . . . n. The distance along the beam is s. The vertical deflection and twist angle are denoted by U(s) and φ(s) respectively.

For small deformations the deflection is given by A. Blake, “Handbook of Mechanics, Materials, and Structures,” New York: Wiley, 1985:

$$\begin{matrix}\frac{{M}_{i}}{{E}_{i} {I}_{i}} + \frac{ϕ ( s )}{R} + \frac{{d}^{2} U ( s )}{d {s}^{2}} = 0 & ( 1 ) \\ - \frac{d ϕ ( s )}{d s} + \frac{1}{R} \frac{d U ( s )}{d s} = 0 & ( 2 )\end{matrix}$$

If the beam is clamped at s=0, the boundary conditions are U(0)=0, U′(0)=0 and φ(0)=0. Solving (1) and (2) and imposing boundary conditions,

$$\begin{matrix}U ( s ) = \frac{{M}_{i} {R}^{2}}{{E}_{i} {I}_{i}} ( - 1 + cos ( \frac{s}{R} ) ) & ( 3 ) \\ ϕ ( s ) = \frac{U ( s )}{R} & ( 4 )\end{matrix}$$

FIG. 2B shows the cross-section of area Aᵢ of the curved beam. The origin of the local u-r coordinate system coincides with the centroid of this cross-section. Let Jᵢ be defined by the area integral, A. E. Armenàkas, “Advanced Mechanics of Materials and Applied Elasticity,” Boca Raton: CRC Taylor & Francis, 2005:

$${J}_{i} = {\int }_{{A}_{i}} \int \frac{{u}^{2} d {A}_{i}}{1 - r / R} = \frac{{t}_{i}^{3} R}{12} ln ( \frac{2 R + {w}_{i}}{2 R - {w}_{i}} ) \qquad ( 5 )$$

Then the axial strain produced due to bending moment is given by A. E. Armenàkas, “Advanced Mechanics of Materials and Applied Elasticity,” Boca Raton: CRC Taylor & Francis, 2005:

$${ɛ}_{{M}_{i}} = \frac{{M}_{i} {t}_{i}}{2 {E}_{i} {J}_{i}} \qquad ( 6 )$$

FIG. 3 shows a section of a curved bimorph in accordance with an embodiment of the subject invention. The top and bottom layers are denoted as layer 1 and layer 2 respectively. In the embodiment shown, the layers 1 and 2 have uniform width and cross-section, but can have different thicknesses. Let the Young's modulus and thickness of the ith layer be Eᵢ and tᵢ respectively, i=1, 2. Let the normal force and bending moment acting on layer i be Nᵢ and Mᵢ respectively. Force balance gives,

N₁=N₂=N (7)

Moment balance gives,

$$N ( \frac{{t}_{1} + {t}_{2}}{2} ) = {M}_{1} + {M}_{2} \qquad ( 8 )$$

The strains produced in the top and bottom layers match at the interface between the two. The three components of the total axial strain produced in the ith layer are the strain due to axial force (ε_{N}_{ᵢ}), strain due to bending moment (ε_{M}_{ᵢ}) and strain due to thermal or piezoelectric actuation or both (ε_{act}_{ᵢ}). The strain due to axial force is, S. Timoshenko, J. Opt. Soc. Am., 11, 233-256, 1925:

ε_{N}_{ᵢ}=Nᵢ/(EᵢAᵢ) (9)

The strain due to bending moment is given by (6). Thermal strain is αᵢΔT, where αᵢ is the coefficient of thermal expansion of the ith layer and ΔT is the rise in temperature. M. S. Weinberg, J. MEMS, 8, 529-533, 1999. Piezoelectric strain is given by dᵢξᵢ, where dᵢ and ξᵢ are the piezoelectric coefficient of the ith layer and the electric field in the ith layer respectively. M. S. Weinberg, J. MEMS, 8, 529-533, 1999. If both thermal and piezoelectric effects are present, ε_{act}_{ᵢ} is given by the sum of thermal and piezoelectric strains. Equating the total axial strain at the interface,

ε_{N}_{₁}+ε_{M}_{₁}+ε_{act1}=ε_{N}_{₂}+ε_{M}_{₂}ε_{act2} (10)

The out-of-plane bimorph deflection may be obtained by using (3), (6), (7), (8), (9) and (10),

$$U ( s ) = \frac{{R}^{2} ( - 1 + cos ( s / R ) ) ( {α}_{1} - {α}_{2} ) Δ T}{( \frac{{I}_{1} {t}_{1}}{2 {J}_{1}} + \frac{{I}_{2} {t}_{2}}{2 {J}_{2}} + ( \frac{1}{{A}_{1} {E}_{1}} + \frac{1}{{A}_{2} {E}_{2}} ) ( \frac{2}{{t}_{1} + {t}_{2}} ) ( {E}_{1} {I}_{1} + {E}_{2} {I}_{2} ) )} \qquad ( 11 )$$

The beam twist angle may be obtained by using (4). Next, the analytical expressions can be validated against simulation results.

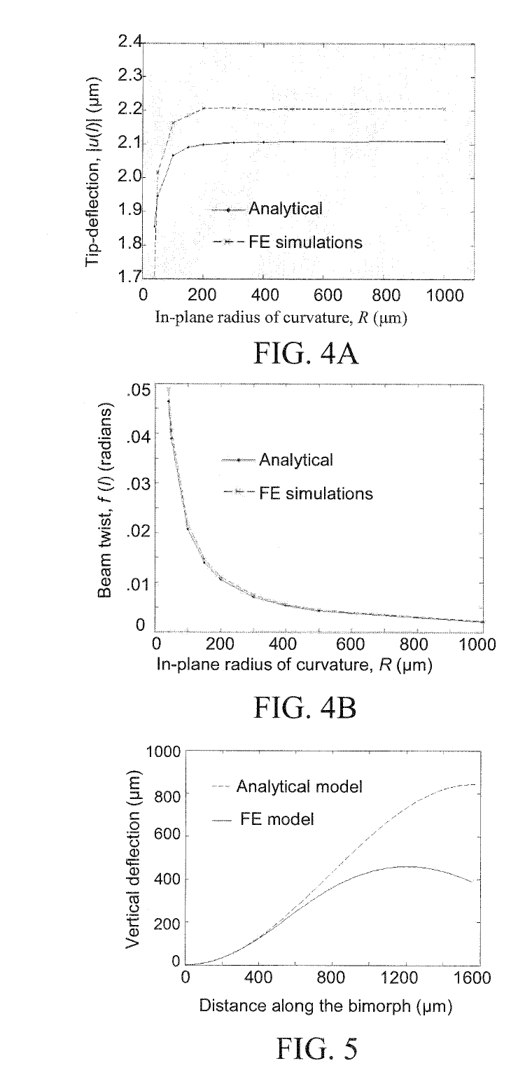

FIGS. 4A-4B show analytical and finite element (FE) simulated tip-deflections (FIG. 4A) and beam twists (FIG. 4B) produced by specific embodiments of the subject invention having the same width, length, and thickness, but having different radii of curvature. The results of FIGS. 4A and 4B are for Al-SiO₂ thermal bimorphs clamped at one end having width w=10 μm, length l=50 μm, and thickness t₁=t₂=1 μm, having in-plane radii of curvature R varying from zero to 1000 microns. The values presented are based on subjecting the stimulated bimorphs to a uniform temperature change of 100 K. FIGS. 4A-4B show good agreement between analysis and FE simulation.

As the calculated deflections are based upon the small deflection theory of curved beams. A. Blake, “Handbook of Mechanics, Materials, and Structures,” New York: Wiley, 1985, large deflections may not follow the calculated deflectors as accurately as smaller deflections. For instance, FIG. 5 shows analytical and FE simulated vertical deflections produced by a particular embodiment of the subject invention. The embodiment is a semicircular Al-SiO₂ bimorph with an in-plane radius of R=500 μm and width w=10 μm. The thickness of both the layers is 1 μm. Assuming the bimorph is initially parallel to the substrate with no bending or twisting deformations, FIG. 5 compares analytical and FE simulation results based on applying a uniform temperature change of 100 K to the bimorph. As shown, there is large discrepancy between analytical and FE results for out-of-plane deflections greater than 200 μm.

As shown by the above analytical and FE simulated results, embodiments of the curved biomorphs can undergo combined out-of-plane bending and twisting upon actuation. In further embodiments, curved bimorphs/multimorphs are produced having arbitrary shapes. By treating the in-plane radius of curvature, R, as a function of the distance along the bimorph s, these further embodiments can be analyzed as discussed above using equations 1-11 and FE analysis. Although illustrative embodiments are discussed herein, other embodiments can have different configurations, stimuli, deformations, and/or functions.

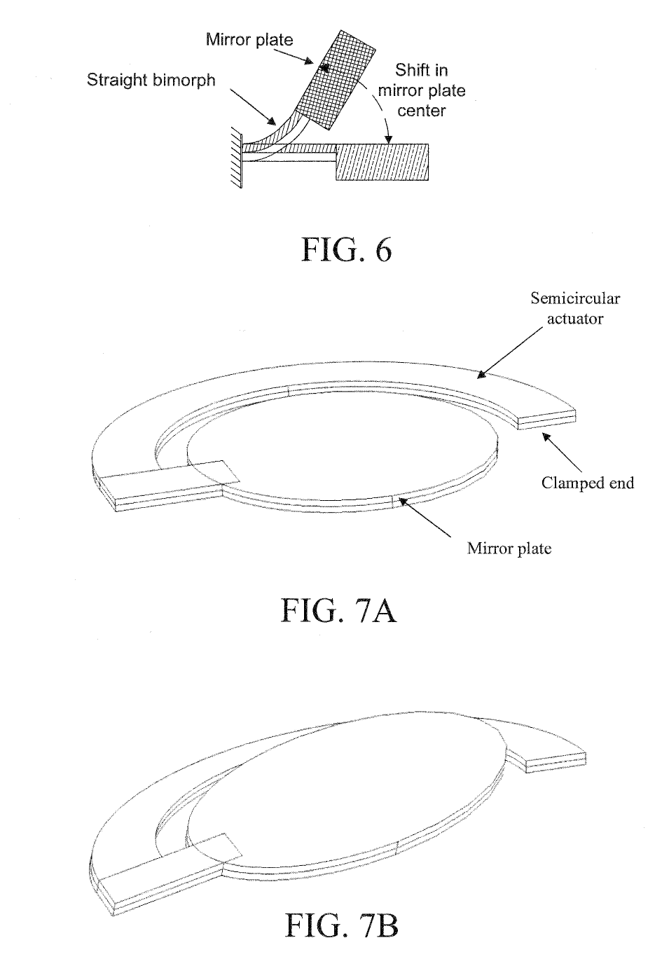

FIG. 6 shows a typical straight electrothermal bimorph based 1D micromirror design at two different positions during a scan cycle. S. Pal and H. Xie, J. Micromech. Microeng., 20, 045020, 2010. As shown, the mirror-plate center shifts significantly during actuation. This makes optical alignment difficult during system design.

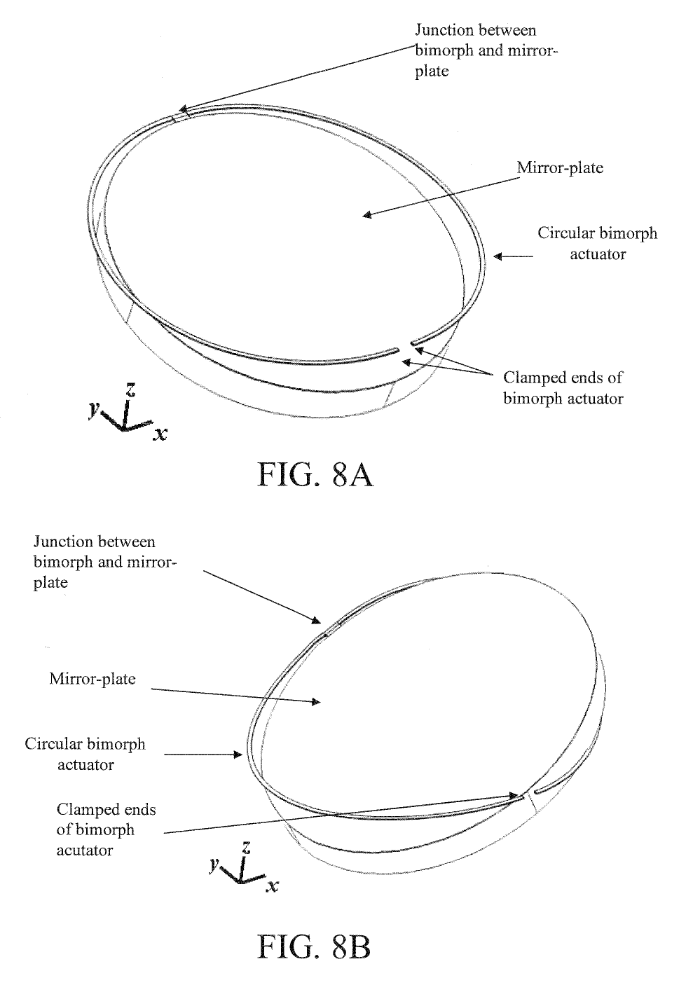

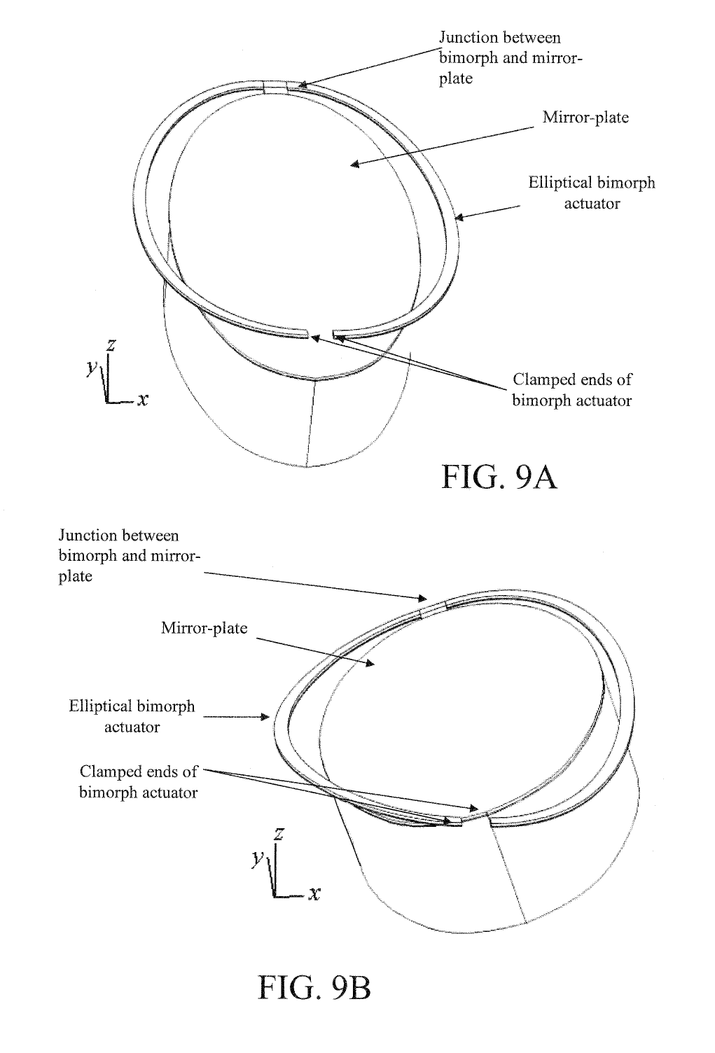

Embodiments of the subject invention significantly decrease or eliminate such center shift. For example, a semicircular actuator is shown in FIG. 7A. In the embodiment shown, a 50 μm wide mirror plate is actuated by an Al-SiO₂ semicircular bimorph with in-plane radius of curvature 35 μm and width 10 μm. The Al and SiO₂ layers are 1 μm thick. FIG. 7B shows the FE results when a uniform temperature change of 200 K is applied to the actuator of FIG. 7A. The magnitude of out-of-plane displacement of the mirror plate is shown and is on the order of 10 microns. From the FE results shown, the mirror-plate tilts by 13.5° when a uniform temperature change of 200K is applied to the actuator. The mirror-plate center shift is less than 0.4 μm. The embodiments shown in FIGS. 8A and 9A also exhibit a small center shift on actuation.

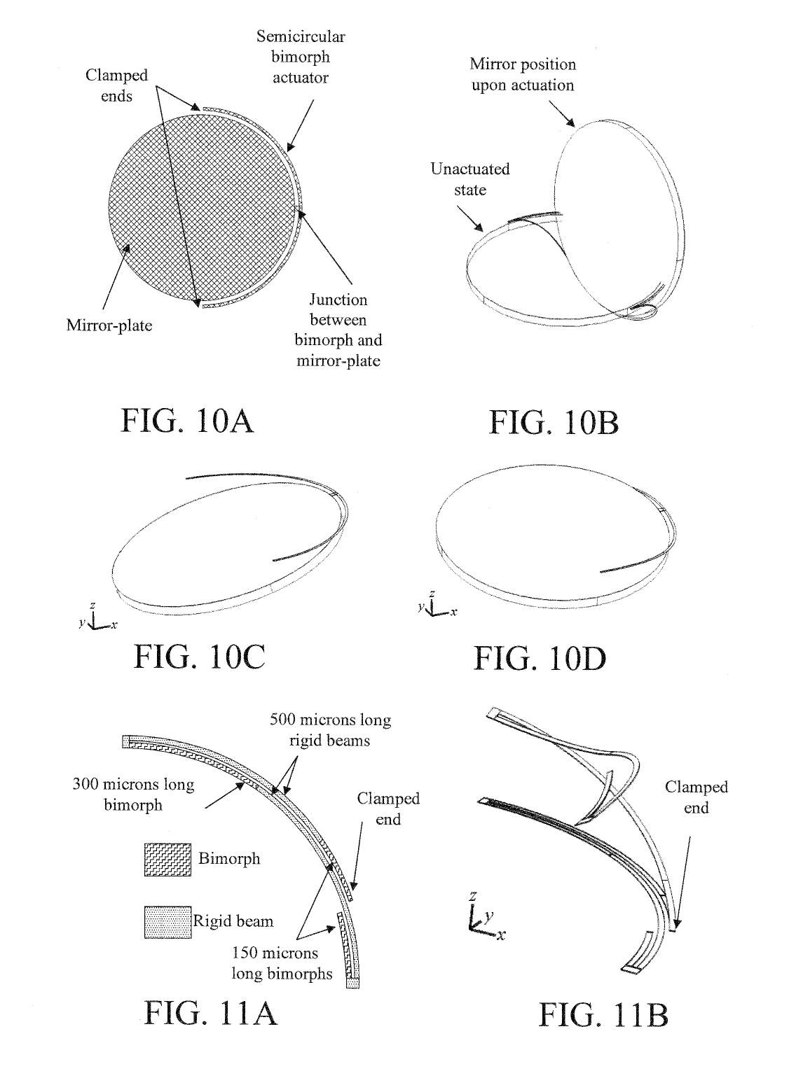

Embodiments of a curved actuator in accordance with the subject invention can achieve 2D scanning using a single actuator. For example, FIGS. 8A and 8B show two scanning resonant modes of a mirror actuated by a circular multimorph actuator. In the embodiment shown, a 400 micron wide circular mirror is actuated by a 5 micron wide circular bimorph beam having a 1 micron thick Al and a 0.4 micron thick W layers. FIG. 8A shows results for a simulated resonant frequency of 319 Hz applied to the actuator. FIG. 8B shows results for a simulated resonant frequency of 408 Hz applied to the actuator. The color gradient shows the relative positions of portions of the apparatus in the three-dimensional coordinate system provided. FIGS. 9A and 9B show two mutually perpendicular resonant scanning modes of a mirror-plate actuated by an elliptical multimorph actuator. The color gradient shows the relative positions of portions of the apparatus in the three-dimensional coordinate system provided. In the embodiment shown, an elliptical micromirror with a 50 micron semi-minor axis and a 100 micron semi-major axis is actuated by a 5 micron wide elliptical bimorph beam having a 1 micron thick Al and 0.4 micron thick W layers. FIG. 9A shows simulated results for a resonant frequency of 2.5 kHz applied to the actuator producing scanning about the x-axis shown. FIG. 9B shows simulated results for a resonant frequency of 4.4 kHz applied to the actuator producing scanning about the perpendicular y-axis. Designs based on curved actuators can have significantly higher resonant frequencies than straight bimorph based designs of comparable dimensions. This is because torsional stiffness of a beam is typically much greater than its bending stiffness. FIG. 10A shows the top view of a micromirror actuated a by semicircular bimorph actuator. FIG. 10B shows mirror actuation due to a temperature change of 200 K. FIG. 10C and 10D show two mutually perpendicular resonant scanning modes produced by the actuator. The relative positions of portions of the apparatus is shown in the three-dimensional coordinate system provided. The embodiment shown in FIG. 10A includes a 1 mm wide mirror plate actuated by a semicircular bimorph actuator. The actuator beam is 10 microns wide and incorporates a 1 micron thick Al and a 0.4 micron thick W layers. FIG. 10C shows an FE simulation of the actuator scanning substantially about an axis (Y-axis) of the mirror plate. FIG. 10D shows an FE simulation of the actuator scanning substantially about a perpendicular axis (X-axis) of the mirror plate. The embodiment shown in FIG. 7A also has two mutually perpendicular scanning modes. FIGS. 8-10 show embodiments allowing mirror scanning about two mutually perpendicular axes by using a single curved actuator. In this way, curved actuators can be used for achieving 2D raster scan using a single actuator. In the embodiments shown in FIGS. 7A, 8A, and 9A, the center-shift produced by beam bending is compensated by the beam twist. Low center-shift is hence achieved. In a specific embodiment, the two mutually perpendicular axes are symmetric axes of the mirror plate.

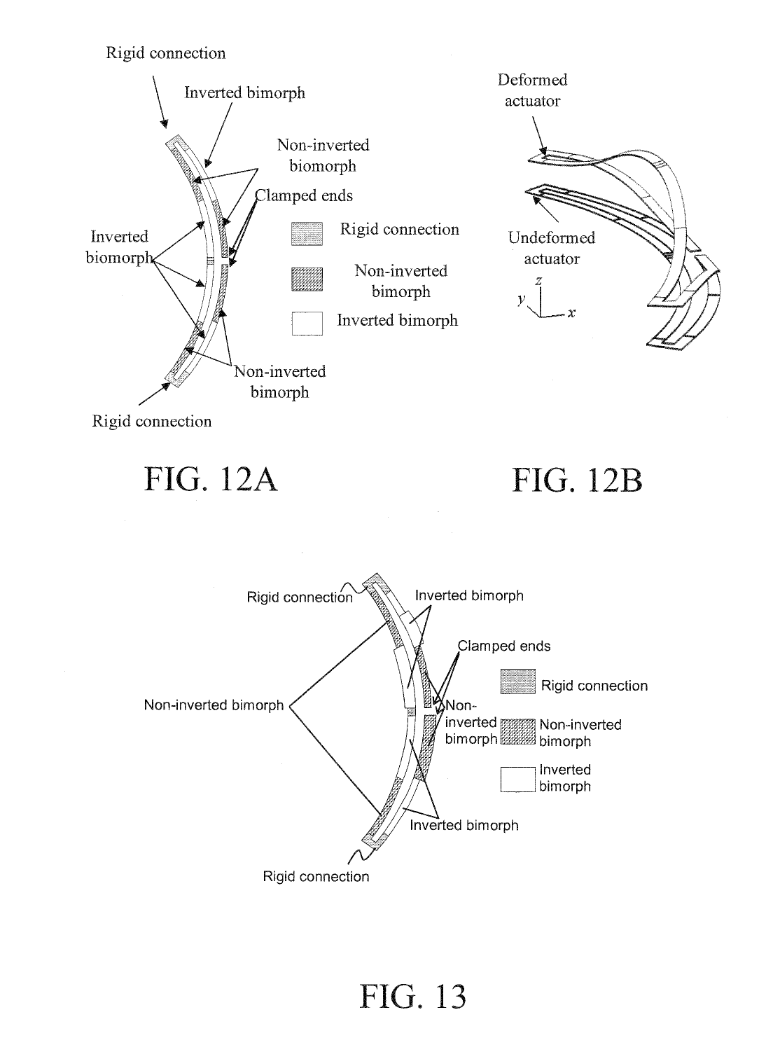

Compound actuators, such as lateral-shift-free (LSF) actuators, L. Wu and H. Xie, “A Lateral-Shift-Free and Large-Vertical-Displacement Electrothermal Actuator for Scanning Micromirror/Lens,” presented at IEEE Transducers, Lyon, France, 2007, and inverted-series-connected (ISC) actuators, K. Jia, S. Pal, and H. Xie, “An Electrothermal Tip-Tilt-Piston Micromirror Based on Folded Dual S-Shaped Bimorphs,” Microelectromechanical Systems, Journal of, vol. 18, pp. 1004-1015, 2009, the teachings of both references, which are incorporated by reference herein in their entirety, can also be utilized in accordance with the subject invention. These actuators utilize two or more straight bimorphs and/or multimorphs and rigid beams to achieve large out of plane displacement. FIGS. 11A-11B and 12A-12B show LSF and ISC designs that utilize curved actuators.

FIGS. 11A-11B show schematics of a curved lateral-shift-free (LSF) actuator in accordance with an embodiment of the subject invention. FIG. 11A shows the actuator in an undeformed condition. In the embodiment shown, the bimorphs incorporate a 1 micron Al on top and a 1 micron SiO2 at the bottom. The radius of curvature of the innermost bimorph is 500 microns. FIG. 11B shows an FE simulation of the LSF actuator after application of a uniform temperature change of 150 K. The color gradient shows z-displacement of the LSF actuator is shown and is on the order of 250 microns.

FIGS. 12A-12B show schematics of a curved inverted-series connected (ISC) actuator in accordance with an embodiment of the subject invention. FIG. 12A shows the actuator in an undeformed condition. In the embodiment shown, FIG. 12A shows a top view of curved ISC actuator. The non-inverted bimorph incorporates a 1 micron Al on top and a 1 micron SiO2 at the bottom. The inverted bimorph consists of a 1 micron SiO2 on top and a 1 micron Al at the bottom. The radius of curvature and length of each bimorph are 500 microns and 160 microns, respectively. FIG. 12B shows an FE simulation of the ISC actuator after application of a uniform temperature change of 150 K. The z-displacement of the ISC actuator is shown and is on the order of 100 microns.

In embodiments, at large deformations, the effective stiffness of the actuators can change significantly from the stiffness in the unactuated state. Therefore, it is possible to realize MEMS devices with variable resonant frequencies.

In embodiments, greater design flexibility may be achieved by using bimorphs and/or multimorphs of different widths. For example, FIG. 13 shows the top view of a curved ISC actuator in accordance with an embodiment of the subject invention. The curved ISC includes eight constituent bimorphs: four inverted bimorphs; and four non-inverted bimorphs. In the embodiment shown, three of the constituent bimorphs are wider than the other bimorphs. As shown, the wider bimorphs can include both the inverted and non-inverted bimorphs. Varying widths can also be used in other compound actuator designs, such LSF actuators. Although only bimorphs are shown here, the widths of constituent multimorphs in a compound actuator can also vary. In a further embodiment, the layers of a single multimorph have varying widths. In another embodiment, constituent multimorphs of a compound actuator have different numbers of layers.

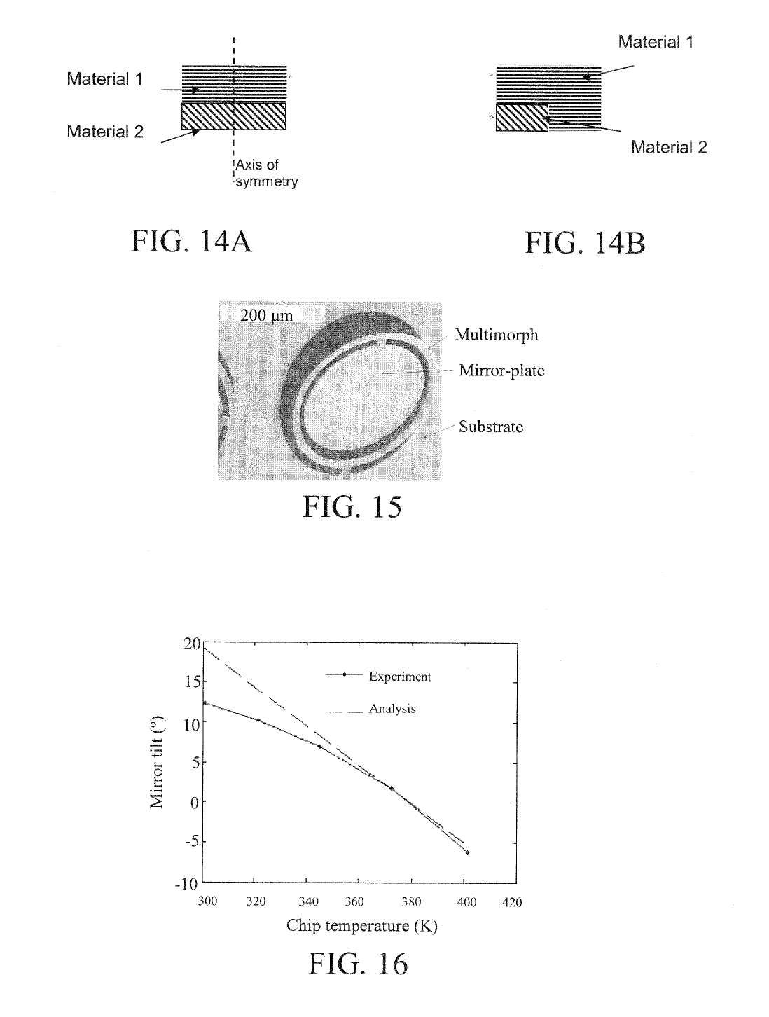

As also shown in FIG. 13, the width of a single multimorph can also vary along the length of the single multimorph. In a further embodiment, the layers of the constituent bimorphs of a compound actuator can have different thicknesses. For example, a first constituent bimorph of a compound actuator can have a 1 micron Al layer and a second constituent bimorph of the compound actuator can have a 2 micron Al layer. In yet another embodiment, the layers of the constituent bimorphs of a compound actuator can include different materials. For example, a first constituent bimorph of a compound actuator can have a Al layer with a SiO₂ layer and a second constituent bimorph of the compound actuator can have a Al layer with a W layer. Additionally, the cross-sectional area of the curved bimorph/multimorph may be tailored to achieve a desired response. For example, the cross-sectional area may or may not have an axis of symmetry. FIG. 14A shows a cross-section of a bimorph having symmetry around a vertical axis of symmetry. FIG. 14B shows a cross-section of a bimorph lacking such symmetry.

### EXAMPLES 1-3

Curved multimorph test structures and electrothermal micromirrors were fabricated on an SOI wafer with 20 μm device layer thickness. The test results on curved multimorph test structure (Example 1), a circular micromirror (Example 2), and an elliptical micromirror (Example 3).

### Example 1

### Curved Test Structure Subjected to Uniform Temperature Change

FIG. 15 shows a SEM of a curved multimorph test structure in accordance with an embodiment of the invention. The multimorph bends and twists upon release due to residual stresses. The multimorph thin-film layers from bottom to top are 0.14 um PECVD SiO2, 0.6 μm sputtered W, 0.29 μm PECVD SiO2 and 0.58 μm sputter-deposited Al, respectively.

FIG. 16 shows results for the structure shown in FIG. 15. The structure shown in FIG. 15 was placed in an oven with a transparent window. The multimorph deformation was monitored using a laser beam reflected from the mirror-plate. The plot shown in FIG. 16 compares the experimentally obtained multimorph deformation with small-deformation analysis. The analytical and experimental results are in good agreement around 0° mirror-tilt, which corresponds to the small-deformation range.

### Example 2

### A 1 mm Aperture Circular Mirror Actuated by a Semi-Circular Electrothermal Multimorph

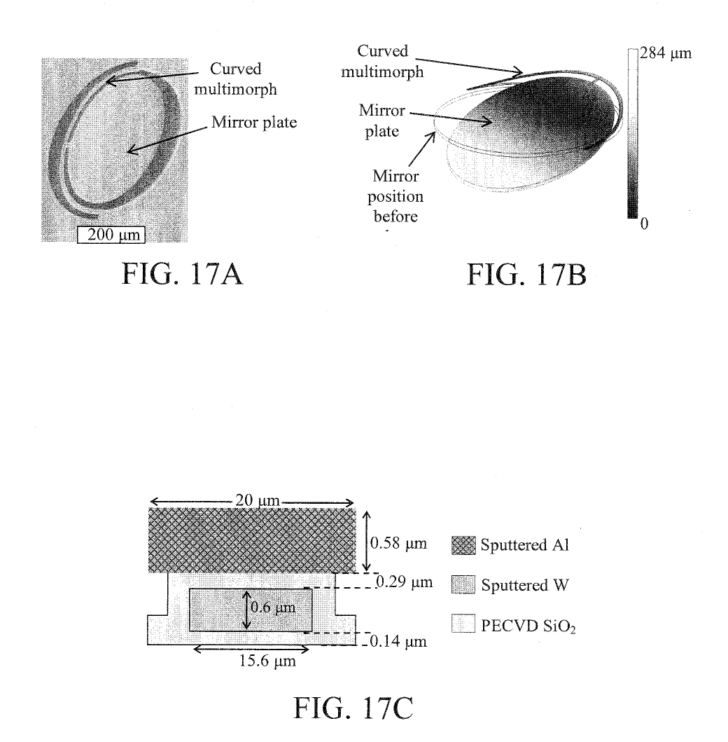

FIG. 17A shows a SEM of a circular micromirror actuated by a semicircular electrothermal multimorph in accordance with an embodiment of the invention. FIG. 17B shows a simulated initial tilt of micromirror upon release of the micromirror of FIG. 17A, where the color bar shows the total displacement from the unreleased, i.e., flat position. FIG. 17C shows a cross-section of multimorph actuator shown in FIG. 17A (not to scale). Tungsten acts as an active layer of the curved actuator and also as a resistive heater.

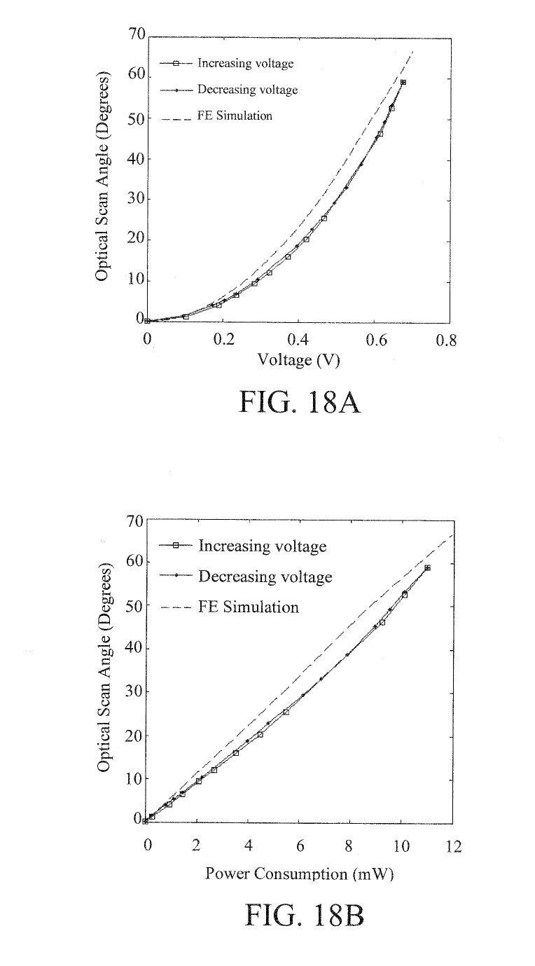

FIGS. 18A and 18B show experimentally obtained static characteristic of the micromirror shown in FIG. 17A along with Finite Element (FE) simulation data, where FIG. 18A shows optical scan angle vs. applied voltage and FIG. 18B optical scan angle vs. input power.

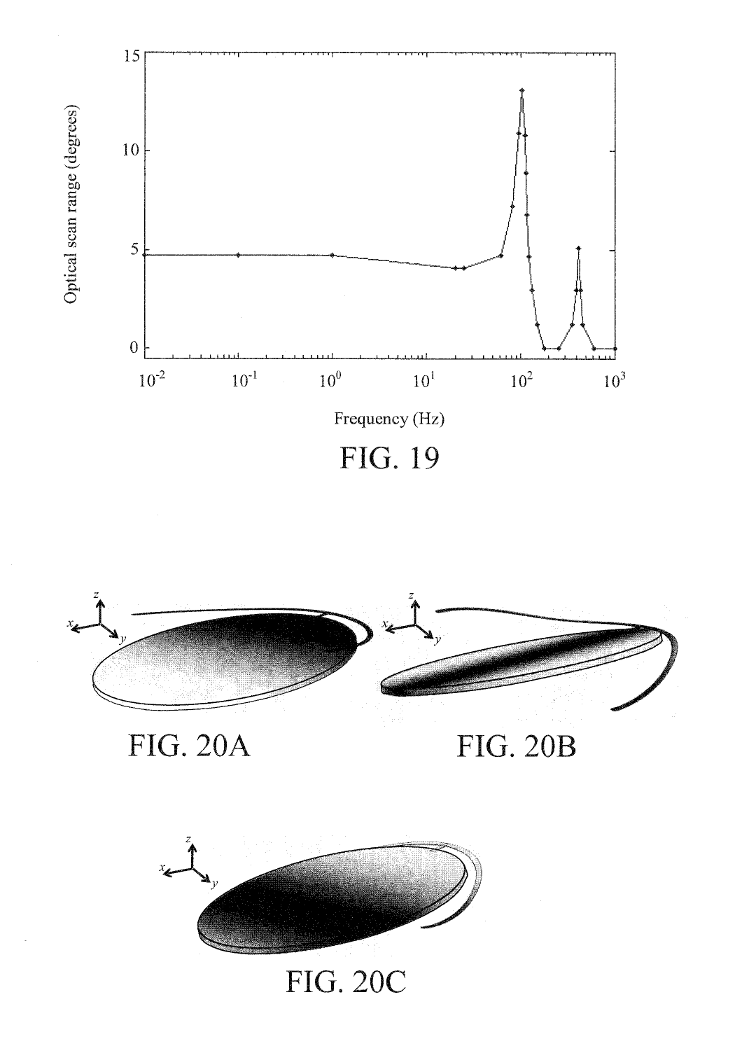

FIG. 19 shows the frequency response of the micromirror shown in FIG. 17A, where the actuation voltage is a sinusoid of amplitude 17.5 mV at a dc bias of 608.5 mV.

FIGS. 20A-20C show resonant modes of the micromirror shown in FIG. 17A, where FIG. 20A shows the resonant mode at 104 Hz, FIG. 20B shows the resonant mode at 400 Hz, and FIG. 20C shows the resonant mode at 416 Hz.

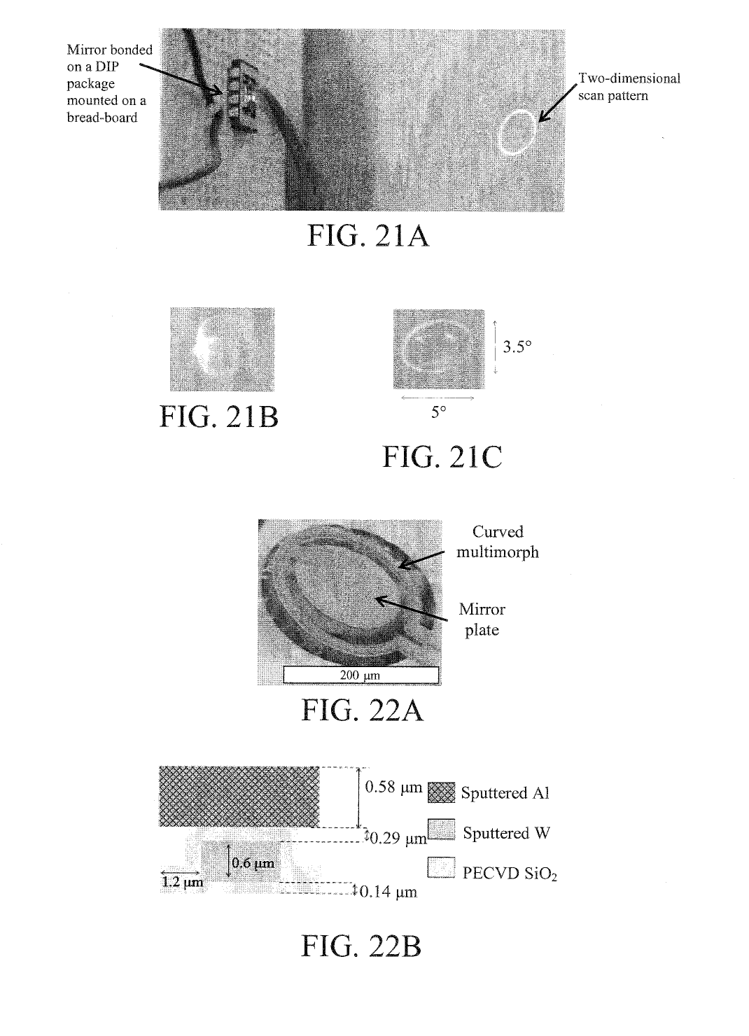

FIGS. 21A-21C show two-dimensional scanning using the minor shown in FIG. 17A, where FIG. 21A shows a scan pattern generated by a 400 Hz, 0-500 mV sinusoidal actuation voltage, FIG. 21B shows a scan pattern generated by a 400 Hz, 0-500 mV sine wave amplitude modulated at 10 Hz and a depth of modulation of 100%, and FIG. 21C shows a smiley face pattern generated by driving the laser diode with a signal synchronized with the mirror actuation waveform.

### Example 3

### A Micromirror Actuated by an Elliptical Multimorph

FIG. 22A shows an SEM of an electrothermal micromirror actuated by elliptical multimorph in accordance with an embodiment of the invention, where the elliptical mirror-plate has 140 μm major axis and 90 μm minor axis. FIG. 22B shows a cross-section of the curved multimorph of FIG. 22A (not to scale). Tungsten acts as an active layer of the curved actuator and also as a resistive heater.

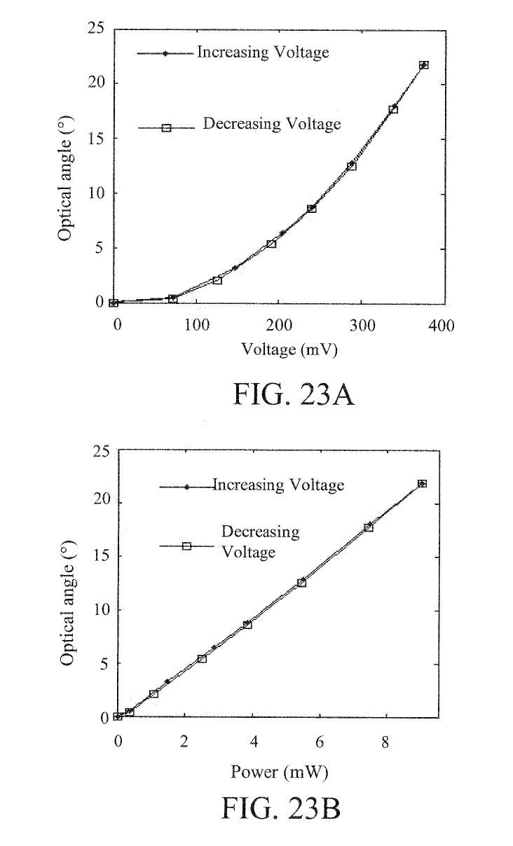

FIGS. 23A-23B show experimentally obtained static characteristic of the micromirror shown in FIG. 22A, where FIG. 23A shows optical angle vs. dc voltage and FIG. 23B shows optical angle vs. dc power input for device.

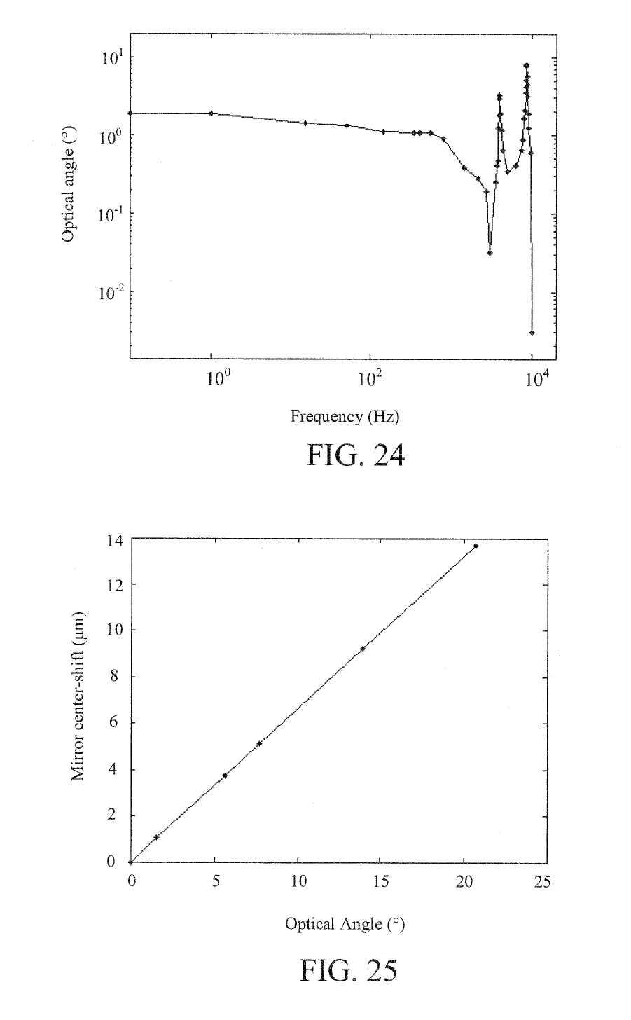

FIG. 24 shows the frequency response obtained for the mirror shown in FIG. 22A, where the actuation signal is a sine wave of 16 mV amplitude at 334 mV offset

FIG. 25 shows a center-shift for the mirror shown in FIG. 22A, where the center-shifts produced by bending and twisting of the curved multimorph are in opposite directions and this results in an overall low center-shift.

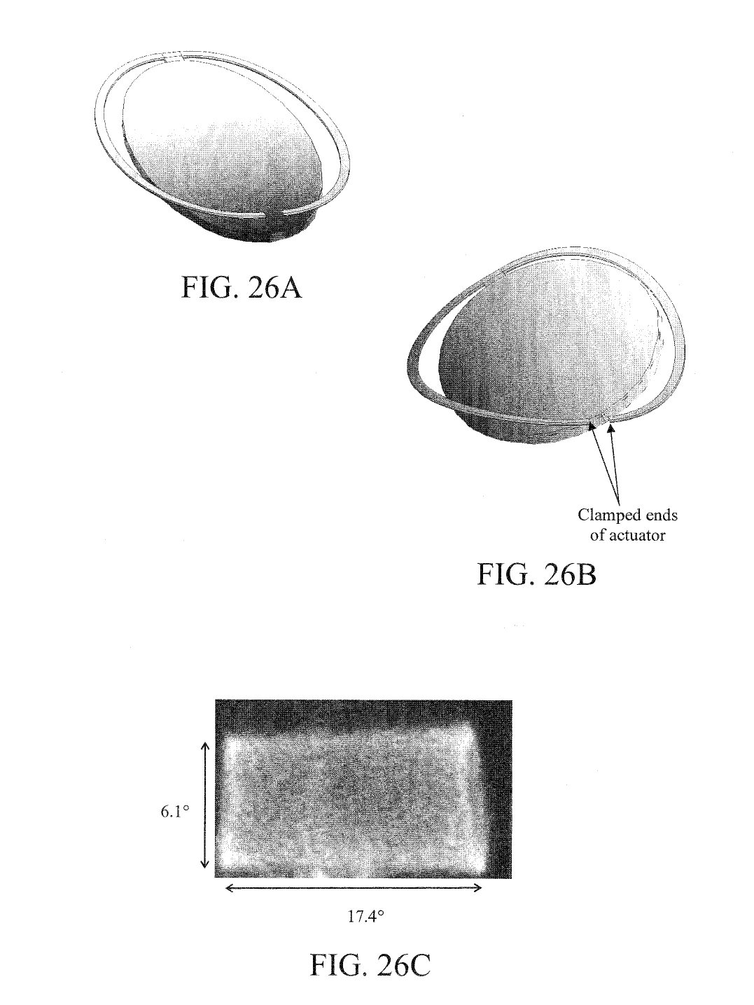

FIGS. 26A-26C show mutually perpendicular scan modes of the mirror shown in FIG. 22A, where FIG. 26A is at 8.6 kHz and FIG. 26B is at 17 kHz, and FIG. 26C shows a two-dimensional scan pattern generated by the mirror shown in FIG. 22A, where the mirror is actuated by a 0-312 mV, 17 kHz sinusoidal waveform amplitude modulated at 8.04 kHz.

The actuator embodiments shown and discussed herein are illustrative. Other embodiments are possible including different materials; having different widths, lengths, thicknesses, or radii of curvature; or being subjected to different stimuli.

In an embodiment, one or more suitably programmed computers are used to control one or more stimuli applied to at least one actuator. Such stimuli can include signals transmitted to the at least one actuator. In an embodiment, the one or more suitably programmed computers comprise a processing system as described below.

In an embodiment, a method of controlling at least one actuator is provided including receiving commands, determining one or more stimuli needed to execute the command, and transmitting the one or more stimuli to the at least one actuator. In an embodiment, one or more of steps of the method for are preformed by one or more suitably programmed computers. In a particular embodiment, the determining step is preformed by the one or more suitably programmed computers. Computer-executable instructions for performing these steps can be embodied on one or more computer-readable media as described below. In an embodiment, the one or more suitably programmed computers comprise a processing system as described below.

Aspects of the invention can be described in the general context of computer-executable instructions, such as program modules, being executed by a computer. Generally, program modules include routines, programs, objects, components, data structures, etc., that perform particular tasks or implement particular abstract data types. Such program modules can be implemented with hardware components, software components, or a combination thereof. Moreover, those skilled in the art will appreciate that the invention can be practiced with a variety of computer-system configurations, including multiprocessor systems, microprocessor-based or programmable-consumer electronics, minicomputers, mainframe computers, and the like. Any number of computer-systems and computer networks are acceptable for use with the present invention.

Specific hardware devices, programming languages, components, processes, protocols, formats, and numerous other details including operating environments and the like are set forth to provide a thorough understanding of the present invention. In other instances, structures, devices, and processes are shown in block-diagram form, rather than in detail, to avoid obscuring the present invention. But an ordinary-skilled artisan would understand that the present invention can be practiced without these specific details. Computer systems, servers, work stations, and other machines can be connected to one another across a communication medium including, for example, a network or networks.

As one skilled in the art will appreciate, embodiments of the present invention can be embodied as, among other things: a method, system, or computer-program product. Accordingly, the embodiments can take the form of a hardware embodiment, a software embodiment, or an embodiment combining software and hardware. In an embodiment, the present invention takes the form of a computer-program product that includes computer-useable instructions embodied on one or more computer-readable media. Methods, data structures, interfaces, and other aspects of the invention described above can be embodied in such a computer-program product.

Computer-readable media include both volatile and nonvolatile media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to, information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently. In an embodiment, non-transitory media are used.

The invention can be practiced in distributed-computing environments where tasks are performed by remote-processing devices that are linked through a communications network or other communication medium. In a distributed-computing environment, program modules can be located in both local and remote computer-storage media including memory storage devices. The computer-useable instructions form an interface to allow a computer to react according to a source of input. The instructions cooperate with other code segments or modules to initiate a variety of tasks in response to data received in conjunction with the source of the received data.

The present invention can be practiced in a network environment such as a communications network. Such networks are widely used to connect various types of network elements, such as routers, servers, gateways, and so forth. Further, the invention can be practiced in a multi-network environment having various, connected public and/or private networks.

Communication between network elements can be wireless or wireline (wired). As will be appreciated by those skilled in the art, communication networks can take several different forms and can use several different communication protocols.

Embodiments of the subject invention can be embodied in a processing system. Components of the processing system can be housed on a single computer or distributed across a network as is known in the art. In an embodiment, components of the processing system are distributed on computer-readable media. In an embodiment, a user can access the processing system via a client device. In an embodiment, some of the functions or the processing system can be stored and/or executed on such a device. Such devices can take any of a variety of forms. By way of example, a client device may be a desktop or laptop computer, a personal digital assistant (PDA), an MP3 player, a communication device such as a telephone, pager, email reader, or text messaging device, or any combination of these or other devices. In an embodiment, a client device can connect to the processing system via a network. As discussed above, the client device may communicate with the network using various access technologies, both wireless and wireline. Moreover, the client device may include one or more input and output interfaces that support user access to the processing system. Such user interfaces can further include various input and output devices which facilitate entry of information by the user or presentation of information to the user. Such input and output devices can include, but are not limited to, a mouse, touch-pad, touch-) screen, or other pointing device, a keyboard, a camera, a monitor, a microphone, a speaker, a printer, a scanner, among other such devices. As further discussed above, the client devices can support various styles and types of client applications.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. A microactuator assembly, comprising:
a beam, wherein the beam is curved along a length of the beam in a plane, wherein each beam comprises:
a first layer comprising a first material; and
a second layer comprising a second material,
wherein the beam bends out of the plane and twists along at least a portion of the length of the beam when the beam is exposed to a stimulus.

2. The microactuator assembly according to claim 1, wherein the beam further comprises a plurality of additional layers comprising a corresponding plurality of additional materials.

3. The microactuator assembly according to claim 1, further comprising an object to be moved, wherein the object is attached to the beam, wherein as the beam bends and twists the object moves.

4. The microactuator assembly according to claim 3, wherein the object is rotated about a first axis in response to a first stimulus.

5. The microactuator assembly according to claim 4, wherein a center of the object is not significantly shifted when the object is rotated about the first axis.

6. The microactuator assembly according to claim 4, wherein the object is rotated about a second axis in response to a second stimulus.

7. The microactuator assembly according to claim 6, wherein the center of the object is not significantly shifted when the object is rotated about the second axis.

8. The microactuator assembly according to claim 4, wherein the first axis is perpendicular to the second axis.

9. The microactuator assembly according to claim 8, wherein the first axis is a symmetric axis of the object.

10. The microactuator assembly according to claim 9, wherein the object experiences no significant movement of the symmetric axis of the object relative to the extent of rotation of the object.

11. The microactuator assembly according to claim 1, wherein the stimulus produces thermal actuation.

12. The microactuator assembly according to claim 1, wherein the stimulus produces piezoelectric actuation.

13. The microactuator assembly according to claim 1, wherein the stimulus is an electric current.

14. The microactuator assembly according to claim 1, wherein the first layer has a first width, a first thickness, and a first radius of curvature, wherein the second layer has a second width, a second thickness, and a second radius of curvature, wherein the first width and the second width are in the plane, wherein the first thickness and the second thickness are perpendicular to the plane.

15. The microactuator assembly according to claim 14, wherein the first width is the same as the second width.

16. The microactuator assembly according to claim 14, wherein the first width is different than the second width

17. The microactuator assembly according to claim 14, wherein the first thickness is the same as the second thickness.

18. The microactuator assembly according to claim 14, wherein the first thickness is different than the second thickness.

19. The microactuator assembly according to claim 14, wherein the first radius of curvature is the same as the second radius of curvature.

20. The microactuator assembly according to claim 14, wherein the first radius of curvature is different than the second radius of curvature

21. The microactuator assembly according to claim 1, further comprising at least one additional beam, wherein each additional beam is curved along a corresponding additional length of each additional beam in the plane, wherein each additional beam comprises:
a corresponding additional first layer comprising the first material; and
a corresponding additional second layer comprising the second material,
wherein each additional beam bends out of the plane and twists along at least a portion of the corresponding additional length of each additional beam when each additional beam is exposed to a corresponding additional stimulus.

22. The microactuator assembly according to claim 1, further comprising at least one straight beam, wherein each straight beam comprises:
a first straight layer comprising the first material; and
a second straight layer comprising the second material,
wherein each straight beam bends along a straight length of each straight beam when each straight beam is exposed to a corresponding at least one stimulus.

23. The microactuator assembly according to claim 3, wherein application of a scanning stimulus produces a scanning motion of the object.

24. The microactuator assembly according to claim 23, wherein application of a resonant scanning stimulus produces a resonant scanning motion of the object.

25. The microactuator assembly according to claim 3, wherein the object is selected from the group consisting of: a mirror plate, an antenna, a radiation beam source, a laser beam source, and a mirror.

26. The microactuator assembly according to claim 3, wherein application of a tip/tilt stimulus produces a tip/tilt motion of the object.

27. The microactuator assembly according to claim 3, wherein application of piston stimulus produces a piston motion of the object.

28. The microactuator assembly according to claim 26, wherein application of piston stimulus produces a piston motion of the object.

29. The microactuator assembly according to claim 1, wherein the beam is clamped at a first end, such that the first end of the beam does not move.

30. The microactuator according to claim 1, wherein the beam has a radius of curvature that varies as a function of distance along the length of the beam.

31. A method of moving an object, comprising:
providing a microactuator assembly, wherein the microactuator assembly comprises:
a beam, wherein the beam is curved along a length of the beam in a plane, wherein each beam comprises:
a first layer comprising a first material; and
a second layer comprising a second material,
wherein the beam bends out of the plane and twists along at least a portion of the length of the beam when the beam is exposed to a stimulus; connecting an object to the microactuator assembly; and exposing the beam to the stimulus.

32-60. (canceled)
